(19) United States
(12) Patent Application Publication
(10) Pub. No.: US 2012/0307160 A1
(43) Pub. Date: Dec. 6, 2012

(54) DISPLAY PANEL AND DISPLAY DEVICE

(75) Inventor: Masashi Yokota, Osaka (JP)

(73) Assignee: SHARP KABUSHIKI KAISHA, Osaka (JP)

(21) Appl. No.: 13/578,347

(22) PCT Filed: Jan. 14, 2011
(86) PCT No.: PCT/JP2011/050518

§ 371 Date: Aug. 10, 2012

(30) Foreign Application Priority Data
Mar. 2, 2010 (JP) 2010-045225

(51) Int. Cl. H04N 5/44; G02F 1/1335; G02F 1/13357

(52) U.S. Cl. 348/725; 349/65; 349/96; 348/E05.096

(57) ABSTRACT

A multi-layered optical member unit to be contained in a liquid crystal display panel, which comprises, from the light ejection side toward the light reception side, a first refractive layer, a light collection layer, and a reflective polarizing layer.

### TECHNICAL FIELD

The present invention relates to a display panel exemplified by a liquid crystal display panel, and a display device (such as a liquid crystal display device) equipped with such a display panel.

### BACKGROUND ART

Among display devices equipped with a non-self-luminous display panel such as, for example, a liquid crystal display device is typically equipped with a backlight unit (an illumination device) as well to supply light to the liquid crystal display panel. There are various kinds of light sources for backlight units. Examples of such light sources include an LED (Light Emitting Diode) and a fluorescent tube.

Light from such a light source passes through various kinds of optical members to be converted into planar light which is suitable for the liquid crystal display panel. For example, in the case of the liquid crystal display device of Patent Literature 1, light from a light source passes through optical members, which are stacked together including a spacer, to reach the liquid crystal display panel.

### CITATION LIST

Patent Literature 1 JP-A-2008-517326

### SUMMARY OF INVENTION

### Technical Problem

However, since the plurality of optical members (such a group of optical members will be referred to as an optical member unit) are stacked together including a spacer, the resulting stack of the optical members includes an air layer. Two layers (optical members) in the stack between which the air layer exists do not closely contact each other over their whole area, and thus are prone to sag over time. Sag of such optical members may damage the quality of the planar light which is incident on the liquid crystal display panel (specifically, the planar light may include unevenness in light intensity, for example).

In view of the above problems, the present invention aims to provide a display panel that is capable of outputting high-quality planar light by incorporating a plurality of sag-resistant optical members in the display panel, and a display device equipped with such a display panel.

### Solution to Problem

A display panel displays images by transmitting and outputting received light. Here, a side of a display panel that receives light will be referred to as a light entrance side, while a side thereof that is opposite from the light receiving side will be referred to as a light exit side. According to an aspect of the present invention, a display panel includes a multi-layered optical member unit which is disposed on the light entrance side and changes a travel direction of light that travels to the outside. Layers in the multi-layered optical member unit are stacked together in close contact with each other over a whole area thereof, the layers including at least a first refraction layer which refracts light, a light condensing layer which condenses light, and a reflection polarization layer which polarizes light through reflection, which are arranged in this order from the light exit side to the light entrance side.

With this configuration, when the display panel receives light, the received light passes through the layers in the order from the reflection polarization layer, the light condensing layer, and the first refraction layer before it leaves the display panel. Through this process, unevenness in light intensity is corrected or reduced, and meanwhile, improvement of brightness of the light is also achieved. Furthermore, since the layers of the multi-layered optical member unit are stacked together to be in close contact with each other all over their facing surfaces, no air layer is formed between the layers, and this helps make the multi-layered optical member unit more robust as a whole, preventing the layers from sagging. As a result, unevenness in light intensity or a like inconvenience attributable to sagging of the layers is reduced. In other words, the light that enters the display panel is converted into light that is suitable for image display.

In one embodiment of the present invention, the first refraction layer preferably has a refractive index that is lower than a refractive index that a material of the light condensing layer has.

In one embodiment of the present invention, a second refraction layer which refracts light may be interposed between the light condensing layer and the reflection polarization layer. In one embodiment of the present invention, the second refraction layer preferably has a refractive index that is lower than the refractive index that the material of the light condensing layer has.

In one embodiment of the present invention, the multi-layered optical member unit preferably further includes a diffusion layer which diffuses light and is located closer to the light entrance side than the reflection polarization layer is. Further, in one embodiment of the present invention, a third refraction layer which refracts light is interposed between the reflection polarization layer and the diffusion layer. In one embodiment of the present invention, in particular, the third refraction layer preferably has a refractive index that is lower than a material of the diffusion layer has.

According to another aspect of the present invention, a display device includes a display panel having any of the above-described configurations and an illumination device which supplies light to the display panel. According to still another aspect of the present invention, a television receiver includes the above display device.

### Advantageous Effects of Invention

According to the present invention, a multi-layered optical member unit included in a display panel does not include an air layer, and further, is not prone to sagging, and thus, light outputted from the multi-layered optical member unit is not prone to degradation that would be caused by air or sagging of layers of the multi-layered optical member unit.

### BRIEF DESCRIPTION OF DRAWINGS

FIG. 1 is a sectional view of a liquid crystal display panel;

FIG. 2 is a sectional view of a liquid crystal display panel;

FIG. 3 is a sectional view of a liquid crystal display panel;

FIG. 4A is a sectional partial view showing part of a backlight unit having an LED with a lens as a light source;

FIG. 4B is a sectional partial view showing part of a backlight unit having an LED as a light source;

FIG. 4C is a sectional partial view showing part of a backlight unit having a fluorescent tube as a light source;

FIG. 5 is an exploded perspective view of a liquid crystal display device; and

FIG. 6 is an exploded perspective view of a television set incorporating a liquid crystal display device.

### DESCRIPTION OF EMBODIMENTS

### Embodiment 1

Hereinafter, an embodiment of the present invention will be described based on the accompanying drawings. Hatching, reference signs for members, and the like may sometimes be omitted in a drawing for ease of description, and in such a case, a different drawing is to be referred to.

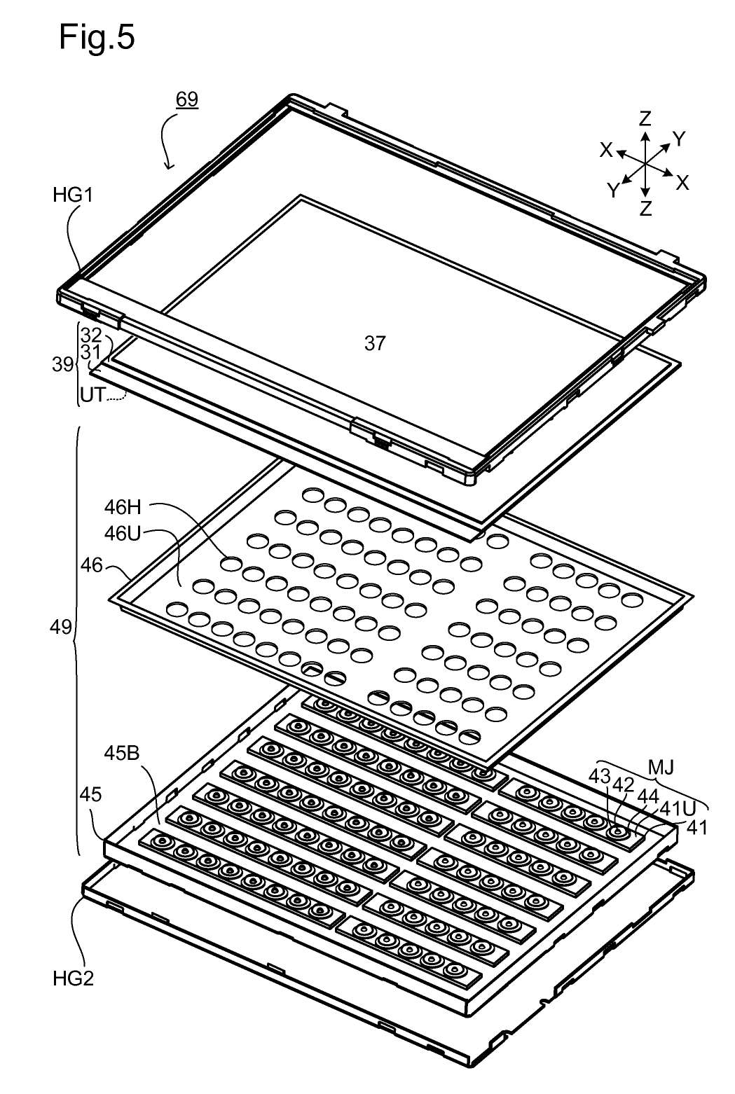

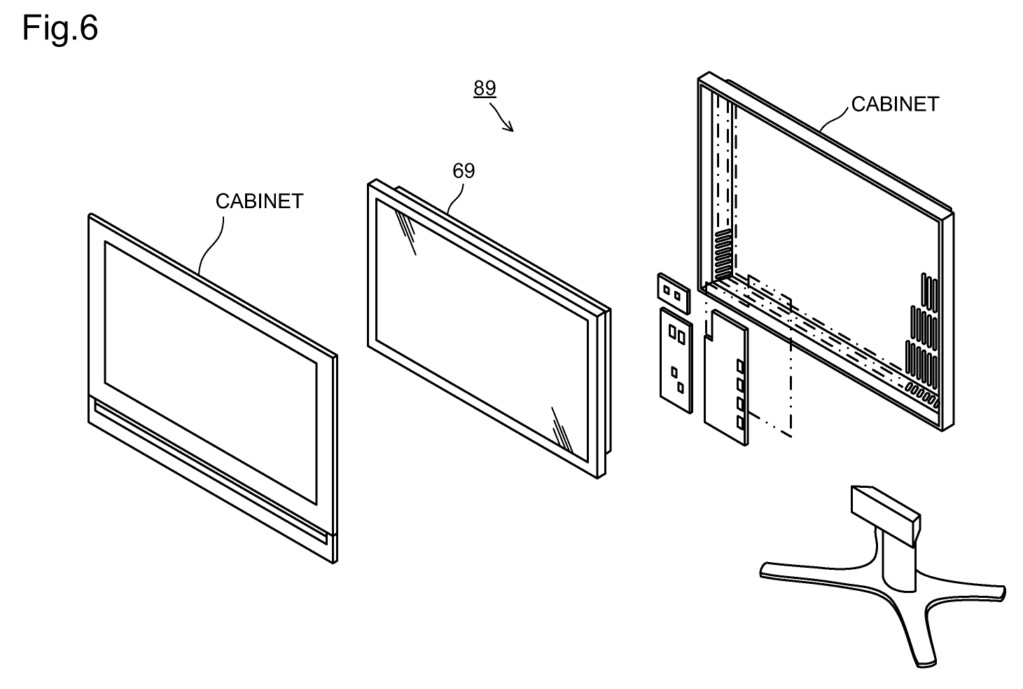

FIG. 6 illustrates a liquid crystal television set 89 equipped with a liquid crystal display device (a display device) 69. The liquid crystal television set 89, which displays images by receiving television broadcast signals, can be regarded as a television receiver. FIG. 5 is an exploded perspective view illustrating a liquid crystal display device. As shown in the figure, the liquid crystal display device 69 includes a liquid crystal display panel 39, a backlight unit (an illumination device) 49 which supplies light to the liquid crystal display panel 39, and housings HG (a front housing HG1 and a rear housing HG2) between which the liquid crystal display panel 39 and the backlight unit 49.

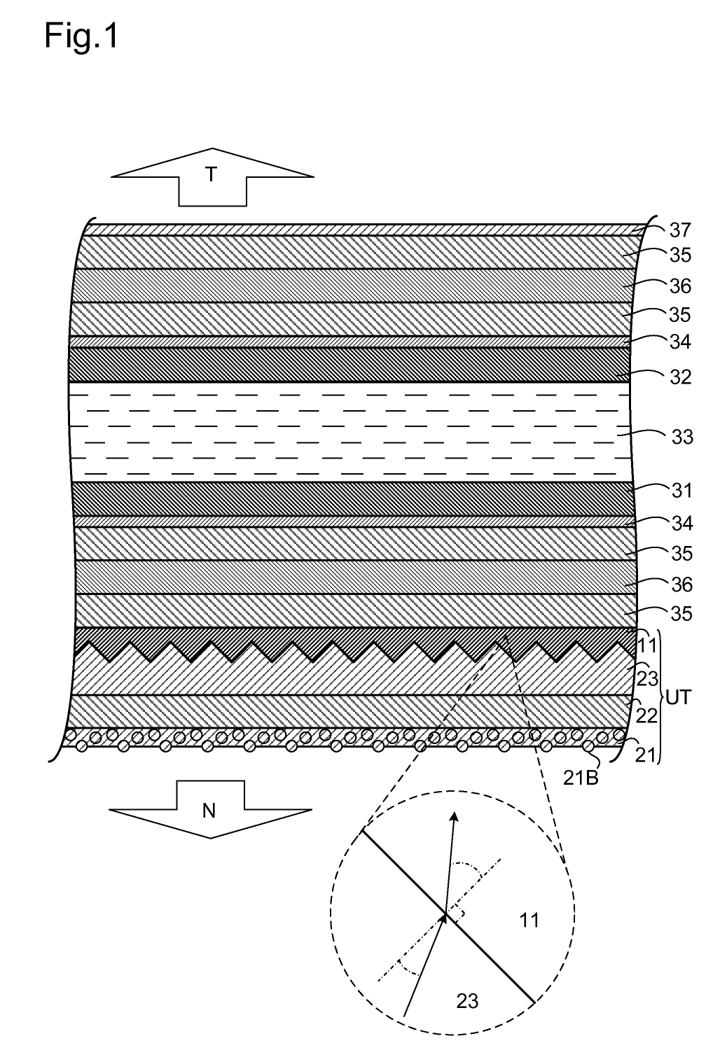

The liquid crystal display panel 39 includes an active matrix substrate 31 which includes a switching device such as a thin film transistor (TFT) and a counter substrate 32 which faces the active matrix substrate 31, and the active matrix substrate 31 and the counter substrate 32 are bonded to each other with a seal member (not shown). Liquid crystal (not shown) is sealed in a gap between the substrates 31 and 32 (see FIG. 1 which will be referred to layter). The liquid crystal display panel 39 makes use of variation in transmittance attributable to inclination of liquid crystal molecules 33 to display images.

The liquid crystal display panel 39 has various optical members fitted on a surface of the active matrix substrate 31 serving as a side (a light entrance side N) for receiving light from the backlight unit 49 and on a surface of the counter substrate 32 serving as a side (a light exit side T) for outputting light for image display. Detailed descriptions will be given later of such various optical members.

Next, a description will be given of the backlight unit 49 which is positioned directly under the liquid crystal display panel 39. The backlight unit 49 includes light emitting diode modules (light emitting modules) MJ, a backlight chassis 45, a large size reflection sheet 46, and the like.

The LED modules MJ each include, as shown in the exploded perspective view of FIG. 5, a mounting substrate 41, an LED (Light Emitting Diode) 42, a lens 43, and a built-in reflection sheet 44.

The mounting substrate 41 has a shape of a rectangular plate, including a mounting surface 41U on which a plurality of electrodes (not shown) are arranged. To each of the electrodes, an LED 42 is attached as a light emitting element. On the mounting surface 41U of the mounting substrate 41, there is formed a resist film (not shown) as a protection film. There is no specific limitation to the resist film, but preferably, the resist film is preferably white and reflective. This is because such a configuration, where light incident on the resist film is reflected on the resist film to travel outward, helps reduce light absorption by the mounting substrate 41, which is a cause of non-uniformity in light intensity.

The LED 42 is a light source and emits light on receiving current via a corresponding one of the electrodes on the mounting substrate 41. Various examples of configurations of the LED 42 are described below. For example, the LED 42 may include a blue-light emitting LED chip (a light emitting chip) and a fluorescent substance that produces yellow light by fluorescence on receiving light from the LED chip (here, there is no specific limitation to the number of LED chips). Such an LED 42 produces white light from the light from the blue-light emitting LED chip and the light produced by fluorescence.

However, the fluorescent substance provided in the LED 42 is not limited to one that produces yellow light by fluorescence. For example, the LED 42 may include a blue-light emitting LED chip and a fluorescent substance that produces green light and red light by fluorescence on receiving light from the LED chip, thereby producing white light from the blue light from the LED chip and the light (green light and red light) produced by fluorescence.

The LED chip provided in the LED 42 is not limited to one that emits blue light. For example, the LED 42 may include a red-light emitting LED chip, a blue-light emitting LED chip, and a fluorescent substance that produces green light by fluorescence on receiving light from the blue-light emitting LED chip. This is because such an LED 42 is able to produce white light from the red light from the red-light emitting LED chip, the blue light from the blue-light emitting LED chip, and the green light generated by fluorescence.

The LED 42 may also be configured without a fluorescent substance. For example, the LED 42 may include a red-light emitting LED chip, a green-light emitting LED chip, and a blue-light emitting LED chip, thereby producing white light from the light from all the LED chips.

Note that the backlight unit 49 illustrated in FIG. 5 is equipped with comparatively short mounting substrates 41 on each of which five LEDs 42 are arranged in a row and comparatively long mounting substrates 41 on each of which eight LEDs 42 are arranged in a row.

In particular, the two kinds of mounting substrates 41 are arranged such that the row of the five LEDs 42 and the row of the eight LEDs 42 together form a row of thirteen LEDs 42, and further, the mounting substrates 41 of the two kinds are also arranged in a direction that intersects (perpendicularly, for example) the direction in which the thirteen LEDs 42 are arranged. As a result, the LEDs 42 are arranged in a matrix pattern to together emit planar light (for the sake of convenience, a direction in which the two different kinds of mounting substrates 41 are arranged will be referred to as direction X, a direction in which the mounting substrates 41 of the same kind are arranged will be referred to as direction Y, and a direction that intersects direction X and direction Y will be referred to as direction Z).

A group of thirteen LEDs 42 arranged in direction X are electrically connected to each other serially, and further, the group of serially connected thirteen LEDs 42 are electrically connected in parallel to another group of thirteen LEDs 42 arranged adjacent to the group of thirteen LEDs 42 in direction Y. With this configuration, the LEDs 42 arranged in the matrix pattern are driven in parallel.

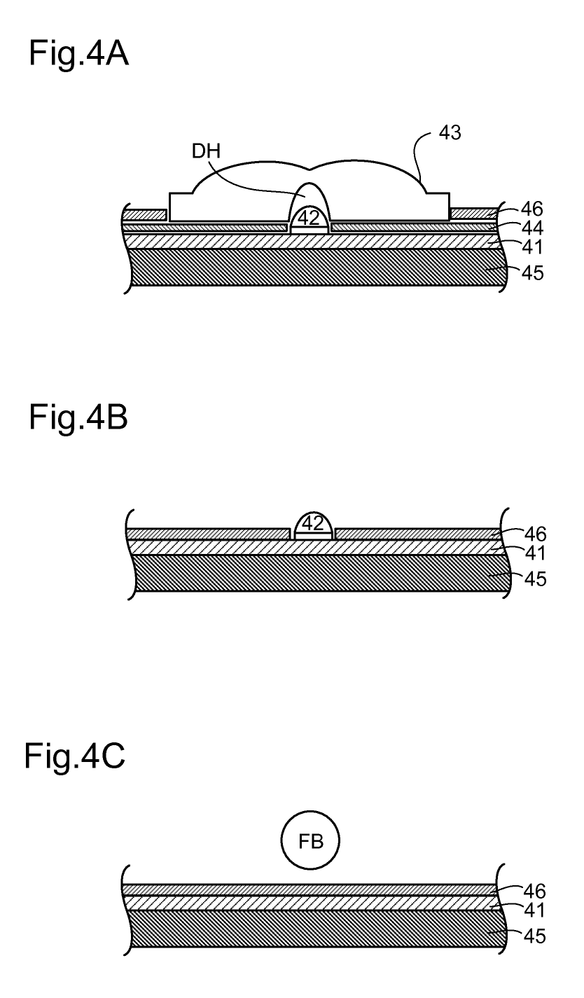

The lens 43 receives light from the LED 42, and transmits (outputs) the received light. More specifically, the lens 43 has a depressed hole DH, which is provided for accommodating the LED 42, formed on a (light entrance surface) side thereof which is opposite from a lens surface thereof; the lens 43 is put in place to cover the LED 42 by aligning the depressed hole DH with the LED 42 (see FIG. 4A which will be referred to later). Then, the LED 42 is embedded inside the lens 43, and light from the LED 42 is securely supplied into the lens 43. Most part of the thus supplied light leaves the lens 43 through the lens surface thereof.

The built-in reflection sheet 44 is interposed between the lens 43 and the mounting substrate 41. The built-in reflection sheet 44 prevents exposure of the mounting surface 41U of the mounting substrate 41 via a later-described through hole 46H formed in the large size reflection sheet 46 to pass the lens 43 therethrough.

Specifically, the large size reflection sheet 46 includes a through hole 46H which is larger than an outer diameter of the lens 43 for the lens 43 to be exposed therethrough above a reflection surface 46U of the large size reflection sheet 46. With this configuration, where the lens 43 is exposed above the reflection surface 46U of the large size reflection sheet 46, there may be formed a gap between an outer edge of the lens 43 and an edge defining the through hole 46H, and through such a gap, the mounting surface 41U of the mounting substrate 41 may be exposed. To prevent such inconvenience, the built-in reflection sheet 44 is disposed along the outer edge of the lens 43, and has a ring shape as shown in FIG. 5, for example.

The backlight chassis 45 is, for example, a box-like member as shown in FIG. 5, and a plurality of LED modules MJ are laid out on a bottom surface 45B of the backlight chassis 45, and thereby, the plurality of LED modules MJ are accommodated in the backlight chassis 45. The bottom surface 45B of the backlight chassis 45 and the mounting substrate 41 of the LED module MJ are connected to each other via an unillustrated rivet.

The large size reflection sheet 46 is an optical sheet including the reflection surface 46U, and disposed over the plurality of LED modules MJ with a rear surface thereof, which is opposite from the reflection surface 46U, facing the LED modules MJ, which are arranged in the matrix pattern. The large size reflection sheet 46 includes through holes 46H formed at positions therein aligned with positions of the lenses 43 of the LED modules MJ, through which the lenses 43 are exposed above the reflection surface 46U (it is preferable to provide through holes for exposing the above-mentioned rivet and a support pin as well).

With this configuration, even if part of light leaving the lens 43 travels in a direction toward the bottom surface 45B of the backlight chassis 45, the part of the light is reflected by the reflection surface 46U of the large size reflection sheet 46 and travels away from the bottom surface 45B. In this way, the provision of the large size reflection sheet 46 makes the light from the LEDs 42 travel to the liquid crystal display panel 39, which faces the reflection surface 46U, without being lost.

Now, a description will be given of the liquid crystal display panel 39 with reference to FIG. 1, which is a sectional view of the liquid crystal display panel 39. As shown in FIG. 1, in the liquid crystal display panel 39, an adhesive layer 34 is formed on a surface of the active matrix substrate 31 and on a surface of the counter substrate 32, and to each of the adhesive layers 34, a polarization film (polyvinyl alcohol film; PAC film) held between TAC (triacetyl cellulose) films 35 is fitted. In other words, a polarization film 36 each surface of which is protected by a TAC film 35 is attached to a surface of the active matrix substrate 31 and a surface of the counter substrate 32 (here, the TAC film 35 and the polarization film 36 are in close contact with each other over the whole area of their facing surfaces).

The two polarization films 36 allow only a specific polarization component of light from the backlight unit 49 to pass through the liquid crystal display panel 39 to be recognized as an image by a user. Preferably, a scratch-resistant coat layer 37 is formed over one of the TAC films 35 that serves as the frontmost surface of the liquid crystal display panel 39.

Furthermore, the liquid crystal display panel 39 includes a multi-layered optical member unit UT on its light entrance side N; the multi-layered optical member unit UT is formed by stacking optical members together. The multi-layered optical member unit UT includes a first refraction layer 11, a light condensing layer 23, a reflection polarization layer 22, and a diffusion layer 21. In the multi-layered optical member unit UT, the first refraction layer 11, the light condensing layer 23, the reflection polarization layer 22, and the diffusion layer 21 are stacked together in this order from the light exit side T to the light entrance side N. That is, the diffusion layer 21 is located on an outermost side (at a position in the multi-layered optical member unit UT that is the farthest away from the active matrix substrate 31), and receives light directly from the backlight unit 49.

The diffusion layer 21 diffuses received light, and is formed as a layer of, for example, a resin (for example, a polyethylene terephthalate or a polycarbonate) containing diffusion beads 21B made of an acrylic resin or a silicone resin. There are various methods of making a resin layer (a base layer) contain the diffusion beads 21B, and an example of such methods is to apply diffusion beads to a base layer by using a UV-curable resin or a thermosetting resin.

The reflection polarization layer 22 reflects and polarizes received light, and is formed as a PET multi-layered film (such as DBEF series by Sumitomo 3M Ltd.), for example. However, the reflection polarization layer 22 is not limited to a PET multi-layered film, and it may be a cholesteric liquid crystal layer or a wire-grid polarizer (which is a member composed of a PET substrate and a reflection layer formed on the PET substrate by parallelly arranging wires of aluminum or the like at a pitch of 200 nm or less). The reflection polarization layer 22 and the diffusion layer 21 are in close contact with each other (adhere each other) over the whole area of their facing surfaces.

The light condensing layer 23 condenses light to thereby improve brightness, and is formed as, for example, a prism sheet where triangular prisms are parallelly arranged. However, the light condensing layer 23 is not limited to a prism sheet, and it may be any sheet having a shape which is capable of condensing light such as a lenticular-lens shape, a micro-lens shape, a hexagonal-lens shape, or a pyramid-lens shape.

Such a sheet having a light condensing shape may be one obtained by forming a light condensing portion of a UV-curable resin on a substrate of a polyethylene terephthalate or the like. Alternatively, a sheet having a light condensing shape may be one collectively obtained as a whole by extruding a typical resin (such as a polycarbonate).

The light condensing layer 23 and the reflection polarization layer 22 are in close contact with each other over the whole area of their facing surfaces. Furthermore, the light condensing layer 23 and the diffusion layer 21 together hold the reflection polarization layer 22 in between.

The first refraction layer 11, which is superposed on the light condensing layer 23, is a resin layer between the TAC film 35 for protecting the polarization film 36 attached to the active matrix substrate 31 and the light condensing layer 23 (here, the TAC film 35 and the first refraction layer 11 are in close contact with each other over the whole area of their facing surfaces, and the first refraction layer 11 and the light condensing layer 23 are in close contact with each other over the whole area of their facing surfaces).

Specifically, the first refraction layer 11 covers an uneven surface (for example, a surface where prisms are parallelly arranged) of the light condensing layer 23, and thereby provides a flat surface over the uneven surface of the light condensing layer 23. That is, the first refraction layer 11 provides a flat surface by covering the uneven surface of the light condensing layer 23 so that the multi-layered optical member unit UT may be stably attached to an outermost one of the TAC films 35 attached to the active matrix substrate 31.

Furthermore, the first refraction layer 11 is preferably formed of a resin having a refractive index that is lower than a refractive index that a resin of which the light condensing layer 23 is made has. With such a configuration, as shown in the enlarged view of FIG. 1, when light (see solid line arrows) from the light condensing layer 23 is incident on the first refraction layer 11, a refraction angle is larger than an incidence angle according to the Snell's Law, and thus the light from the light condensing layer 23 is made, via the first refraction layer 11, to travel along a path that is even more inclined toward a normal line direction of the active matrix substrate 31 (that is, light that passes through the light condensing layer 23 is further condensed).

Thus, for example, in a case where the light condensing layer 23 is mainly formed of a polycarbonate, there is no specific limitation to the material of the first refraction layer 11 as long as the material is a resin having a refractive index that is lower than the order of 1.5 which is the refractive index of the polycarbonate (that is, the refractive index N1 of the first refraction layer 11 is preferably more than 1.0 but less than 1.5).

The following is the advantages obtained with the configuration where the above-described multi-layered optical member unit UT is included in the liquid crystal display panel 39 (in other words, with the multi-layered optical member unit UT attached to the light entrance side N of the substrates 31, 32 which are sandwiched between the polarization films 36 each surface of which is protected by a TAC film 35).

That is, light emitted from the LED module MJ and light reflected from the large size reflection sheet 46U repeatedly goes through multiple reflection while passing through the diffusion layer 21 which is superposed on the large size reflection sheet 46U and the reflection polarization layer 22 which is superposed on the diffusion layer 21, and thereby planar light having uniform brightness is produced (note that the reflection polarization layer 22 helps increase an amount of transmitted light).

Furthermore, in the process of passing through the light condensing layer 23 after the reflection polarization layer 22, the above produced planar light travels along a path that is inclined toward the normal line direction of the active matrix substrate 31, and this helps increase brightness and contrast in the liquid crystal display panel 39. That is, if the multi-layered optical member unit UT includes the first refraction layer 11, the light condensing layer 23, and the reflection polarization layer 22 arranged in this order from the light exit side T to the light entrance side N, light (planar light) emitted from the LEDs 42 arranged in a matrix pattern passes through the multi-layered optical member unit UT and thereby reaches the active matrix substrate 31 as light having high brightness and reduced unevenness in light intensity.

As a result, the quality of images displayed on the liquid crystal display panel 39 is also improved (that is, in order to increase brightness and contrast in the liquid crystal display panel 39, it is necessary to provide the first refraction layer 11, the light condensing layer 23, and the reflection polarization layer 22 in the multi-layered optical member unit UT).

Moreover, the multi-layered optical member unit UT is formed by uniting the layers (11, 23, 22, and 21) together into close contact with each other over the whole area thereof, and further, the multi-layered optical member unit UT is in close contact with the TAC film 35 that protects the polarization film 36 attached to the active matrix substrate 31. Specifically, the diffusion layer 21 and the reflection polarization layer 22 are in close contact with each other over the whole area of their facing surfaces, the reflection polarization layer 22 and the light condensing layer 23 are in close contact with each other over the whole area of their facing surfaces, and further, the light condensing layer 23 and the first refraction layer 11 are in close contact with each other over the whole area of their facing surfaces, and the first refraction layer 11 and the TAC film 35 are in close contact with each other over the whole area of their facing surfaces.

With this configuration, the layers (11, 23, 22, and 21) being united together helps enhance the intensity as the multi-layered optical member unit UT, and this helps prevent the layers (11, 23, 22, and 21) from sagging. Thus, unevenness in light intensity due to sagging of the layers (11, 23, 22, and 21) is also reduced. Furthermore, since the layers (11, 23, 22, and 21) are in close contact with each other, entry of alien substances such as trash and dust between the layers is also prevented. Thus, no deterioration due to alien substances is caused in image quality of the liquid crystal display panel 39 even after a long period of use.

In the embodiments described above, in addition to the diffusion layer 21, the reflection polarization layer 22, the light condensing layer 23, the first refraction layer 11 is included in the multi-layered optical member unit UT, and the first refraction layer 11 is interposed between the light condensing layer 23 and one of the TAC films 35 that is the farthest away from the active matrix substrate 31. The multi-layered optical member unit UT, however, may include another layer.

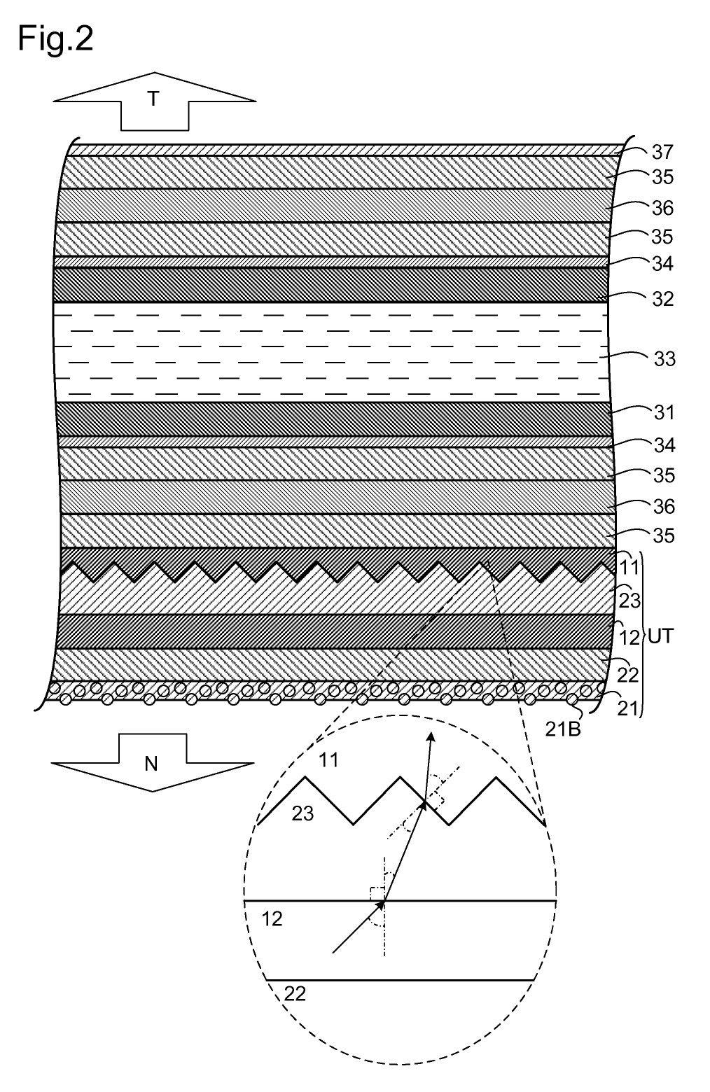

For example, as shown in the sectional view of FIG. 2, a second refraction layer 12 which refracts light may be interposed between the light condensing layer 23 and the reflection polarization layer 22. In particular, it is preferable that the second refraction layer 12 and the light condensing layer 23 be in close contact with each other over the whole area of their facing surfaces and that the second refraction layer 12 and the reflection polarization layer 22 be in close contact with each other over the whole area of their facing surfaces. With this configuration, too, the layers (11, 23, 12, 22, and 21) of the multi-layered optical member unit UT are united together and thus the layers are prevented from sagging, and further, entry of alien substances between the layers is prevented.

Also, the second refraction layer 12 preferably has a refractive index that is lower than the refractive index that the light condensing layer 23 has. With such a configuration, as shown in the enlarged view of FIG. 2, when light (see solid line arrows) from the second refraction layer 12 is incident on the light condensing layer 23, a refraction angle is smaller than an incidence angle according to the Snell's Law, and the light from the second refraction layer 12 reaches a prism surface of a prism in the light condensing layer 23 at a relatively large incidence angle. As a result, light passing through the prism surface travels with a refraction angle that is larger than its incidence angle, and thus easily travels along a path that is inclined toward the normal line direction of the active matrix substrate 31.

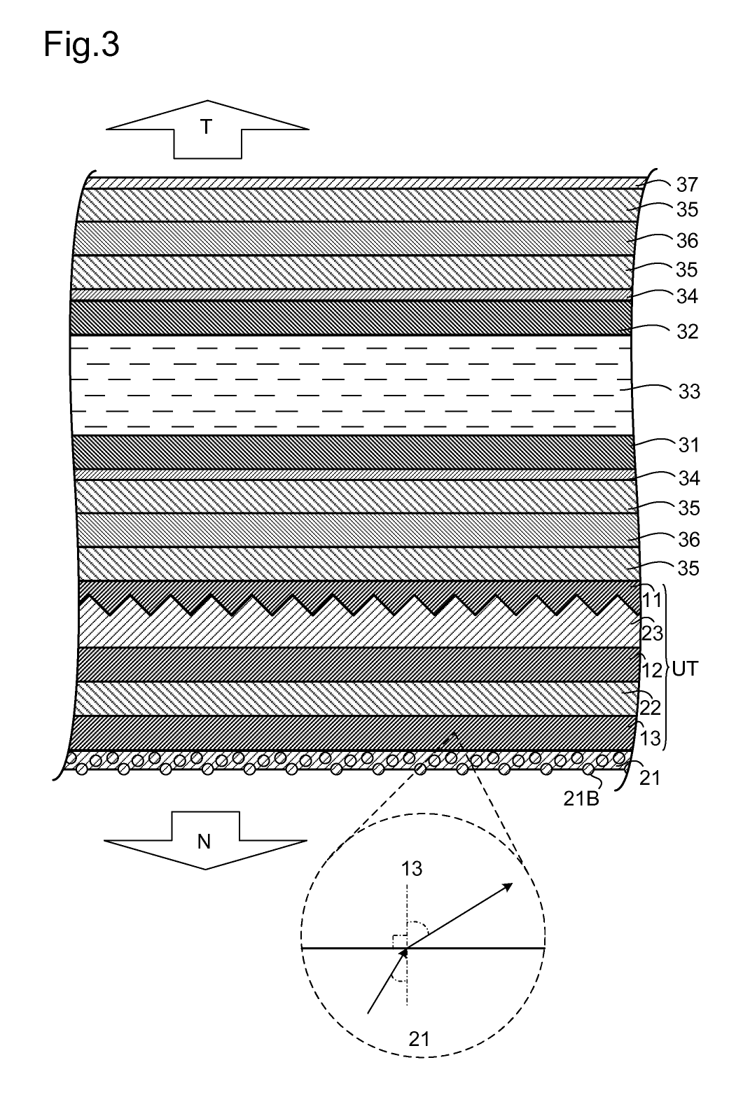

The multi-layered optical member unit UT includes the diffusion layer 21 for diffusing light which is located closer to the light entrance side N than the reflection polarization layer 22, but as shown in the sectional view of FIG. 3, a third refraction layer 13 which refracts light may be interposed between the reflection polarization layer 22 and the diffusion layer 21. In particular, it is preferable that the third refraction layer 13 and the reflection polarization layer 22 be in close contact with each other over the whole area of their facing surfaces and that the third refraction layer 13 and the diffusion layer 21 be in close contact with each other over the whole area of their facing surfaces. With this configuration, too, the layers (11, 23, 12, 22, 13, and 21) of the multi-layered optical member unit UT are united together and thus the layers are prevented from sagging, and further, entry of alien substances between the layers is prevented.

The third refraction layer 13 preferably has a refractive index that is lower than the refractive index that the material of the diffusion layer 21 has. With such a configuration, as shown in the enlarged view of FIG. 3, when light (see solid light angles) from the diffusion layer 21 is incident on the third refraction layer 13, a refraction angle is larger than an incidence angle according to Snell's Law, and thus light from the diffusion layer 21 is more diffused before reaching the reflection polarization layer 22.

### Other Embodiments

It should be understood that the embodiments specifically described above are not meant to limit the present invention, and that many variations and modifications can be made within the spirit of the present invention.

For example, in each of the above embodiments, the layers included in the multi-layered optical member unit UT themselves are adhesive. Thus, no particular adhesive member is required for the layers in the multi-layered optical member unit UT to be in close contact (connection) with each other. This, however, is not meant as a limitation. In a case where the layers in the multi-layered optical member unit UT are not adhesive themselves, a light-transmitting adhesive layer may be interposed between adjacent layers. Needless to say, if a light-transmitting adhesive layer is interposed between adjacent layers, the adhesive layer and each of the adjacent layers are preferably in close contact with each other over the whole area of their facing surfaces.

Furthermore, it is not necessary to interpose an adhesive layer between every pair of adjacent layers as long as an adhesive layer is provided for a non-adhesive layer. That is, in the multi-layered optical member unit UT, as long as all the layers are in close contact with each other as a unit, connection between the layers may be achieved either by adhesiveness of the layers themselves or by adhesive layers interposed between pairs of adjacent layers.

In the embodiments described above, in the backlight unit 49, as shown in the sectional partial view of FIG. 4A, light from the LED 42 is emitted via the lens 43 to the diffusion layer 21. However, the lens 43 is not indispensable. The light from the LED 42 may directly reach the diffusion layer 21 as shown in the sectional partial view of FIG. 4B. Furthermore, the light source is not limited to the LED 42, and, as shown in the sectional partial view of FIG. 4C, a fluorescent tube FB may be adopted instead.

Each of the above embodiments adopts a “direct light source” where light sources are disposed directly under the liquid crystal display panel 39, but this is not meant to limit the present invention. For example, there may be adopted a “side edge type light source” where light sources are disposed at a side of the liquid crystal display panel 39.

### INDUSTRIAL APPLICABILITY

The display panel of the present invention is applicable to a display device incorporated in, for example, a television receiver.

### LIST OF REFERENCE SYMBOLS

UT multi-layered optical member unit

11 first refraction layer

12 second refraction layer

13 third refraction layer

21 diffusion layer

22 reflection polarization layer

23 light condensing layer

31 active matrix substrate

32 counter substrate

33 liquid crystal

34 adhesive layer

35 TAC film

36 polarization film

37 coat layer

39 liquid crystal display panel (display panel)

49 backlight unit (illumination device)

69 liquid crystal display device (display device)

89 liquid crystal television set

1. A display panel, which displays images by transmitting and outputting received light to outside, a side of the display panel that receives light being a light entrance side while a side opposite from the light entrance side being a light exit side,
the display panel comprising
a multi-layered optical member unit which is disposed on the light entrance side and changes a travel direction of light that travels to the outside,
wherein layers in the multi-layered optical member unit are stacked together in close contact with each other over a whole area thereof, the layers including at least a first refraction layer which refracts light, a light condensing layer which condenses light, and a reflection polarization layer which polarizes light through reflection, which are arranged in this order from the light exit side to the light entrance side.

2. The display panel according to claim 1,
wherein
the first refraction layer has a refractive index that is lower than a refractive index that a material of the light condensing layer has.

3. The display panel according to claim 2,
wherein a second refraction layer which refracts light is interposed between the light condensing layer and the reflection polarization layer.

4. The display panel according to claim 3,
wherein
the second refraction layer has a refractive index that is lower than the refractive index that the material of the light condensing layer has.

5. The display panel according to claim 1, further comprising
a diffusion layer which diffuses light and is located closer to the light entrance side than the reflection polarization layer is.

6. The display panel according to claim 5,
wherein
a third refraction layer which refracts light is interposed between the reflection polarization layer and the diffusion layer.

7. The display panel according to claim 6,
wherein the third refraction layer has a refractive index that is lower than a refractive index that a material of the diffusion layer has.

8. A display device, comprising:
the display panel of claim 1; and
an illumination device which supplies light to the display panel.

9. A television receiver comprising the display device according to claim 8.
